(19) United States
(12) Patent Application Publication
(10) Pub. No.: US 2012/0078706 A1
(43) Pub. Date: Mar. 29, 2012

(54) LOCATION PREDICTION PROTOCOL (LPP)

(75) Inventor: Sreeram Rajagopalan, San Jose, CA (US)

(73) Assignee: OPENWAVE SYSTEMS INC., Redwood City, CA (US)

(21) Appl. No.: 12/892,178

(22) Filed: Sep. 28, 2010

(51) Int. Cl. G06Q 30/00

(52) U.S. Cl. 705/14.41

(57) ABSTRACT

In accordance with the invention, embodiments of an ad placement device are described. The ad placement engine calculates a probability parameter that is indicative of a user's likelihood of making a purchase in response to a mobile advertisement. The probability parameter is calculated based on a variety of parameters.

### BACKGROUND

Mobile advertising is a form of advertising via mobile or wireless phones and other similar mobile devices. Typical mobile devices include handhelds, laptops, and dashtops such as dashtop navigation units and dashtop mobile payment platforms. Advertisers and the media industry are increasingly taking into account this fast-growing mobile market.

In some markets, this type of advertising includes a mobile web banner or poster. In other markets, mobile advertisements arrive by short messaging service (SMS). Other forms include multimedia messaging service (MMS) advertising, advertising within mobile games and mobile videos, and mobile television. Additionally, mobile advertising includes full-screen ads, which appear while a requested item of mobile content or mobile web page is loading up, and audio advertisements that can take the form of a jingle before a voicemail recording, or an audio recording played during an interaction with a telephone-based service such as movie ticketing or directory assistance.

Conventional solutions for mobile advertisers are typically based on the current location of a mobile phone subscriber or the area code of a subscriber's mobile phone number. In many cases, the information presented to a subscriber may or may not be relevant causing the subscriber to ignore the information. In turn, this leads to a lower advertisement yield for companies that are looking to convert an ad into a purchase or other action.

### SUMMARY

In accordance with the invention, embodiments of an ad placement device are described. The ad placement engine calculates a probability parameter that is indicative of a user's likelihood of making a purchase in response to a mobile advertisement. The probability parameter is calculated based on a variety of parameters. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a mobile network system.

FIG. 2 depicts a schematic diagram of one embodiment of a mobile network provider of the mobile network system of FIG. 1.

FIG. 3 depicts a schematic diagram of one embodiment of a client computer of the mobile network system of FIG. 1.

FIG. 4 depicts a schematic diagram of one embodiment of an ad placement engine for use with the mobile network provider of FIG. 2 and/or the client computer of FIG. 3.

FIG. 5 depicts a schematic diagram of one embodiment of an ad server of the mobile network system of FIG. 1.

FIG. 6 depicts a schematic flow chart diagram of one embodiment of a location prediction method for use with the ad placement engine of FIG. 4.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes that come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments implement a location prediction protocol (LPP) to calculate a probability parameter in relation to mobile advertising. The LPP is implemented to increase the yield of mobile advertisements when an ad is placed on mobile devices. In other words, the LPP can be use in an ad placement decision in order to place an advertisement that is customized to a specific subscriber, providing an accurate targeting measure and improved tracking of purchase conversion rates. Consequently, the rate at which an ad is converted into a purchase or other action increases. In one embodiment, the LPP includes an algorithm that is computed to provide a probabilistic measure of a consumer's purchase behavior by considering information unique to the consumer.

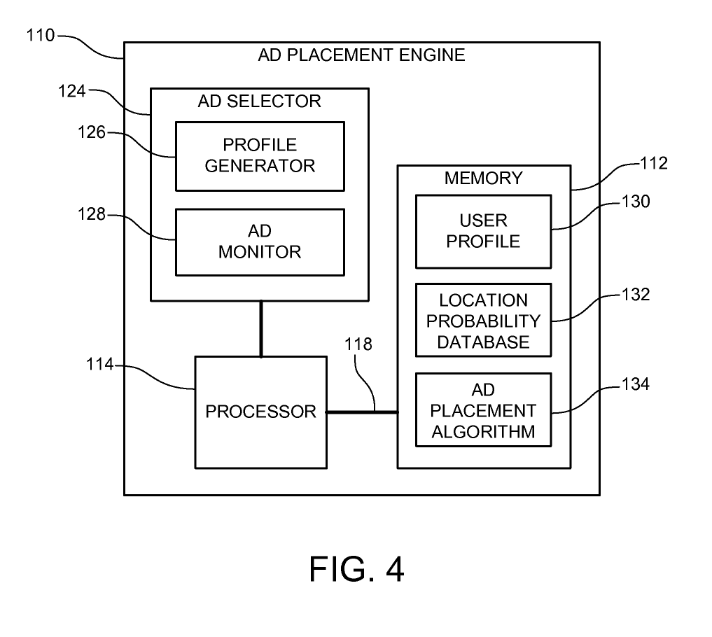

In one embodiment, the LPP takes into account multiple independent variables such as the real-time location of a subscriber, previous purchase decisions, past locations, home base location, the subscriber's typical traffic patterns, and mobile analytics such as a search query performed on a mobile device, etc. A Probability Unit (Probit) function for multivariate regression represents the mathematical relationship between past consumer behavior and the probability of making a purchase. The LPP runs a multivariate regression to determine the probability of purchase, which is the dependent variable of the Probit function. Embodiments of the process to calculate a purchase probability are described in further detail below in relation to FIG. 4. In one embodiment, the probability of purchase parameter has a value between 0 and 100%. Increasing the number of independent variables used by the Probit function increases the fit of this equation, resulting in a more statistically meaningful probabilistic measure. In one embodiment, the LPP sends the probability of purchase parameter to an advertiser. Using the LPP, the advertiser may place an ad on an informed basis to increase the likelihood of the targeted ad resulting in a purchase by a specific consumer. Alternatively, the LPP may be used to implement predetermined rules for an advertiser to participate in advertising activities in which the purchase probability parameter meets standards or criteria set by the advertiser.

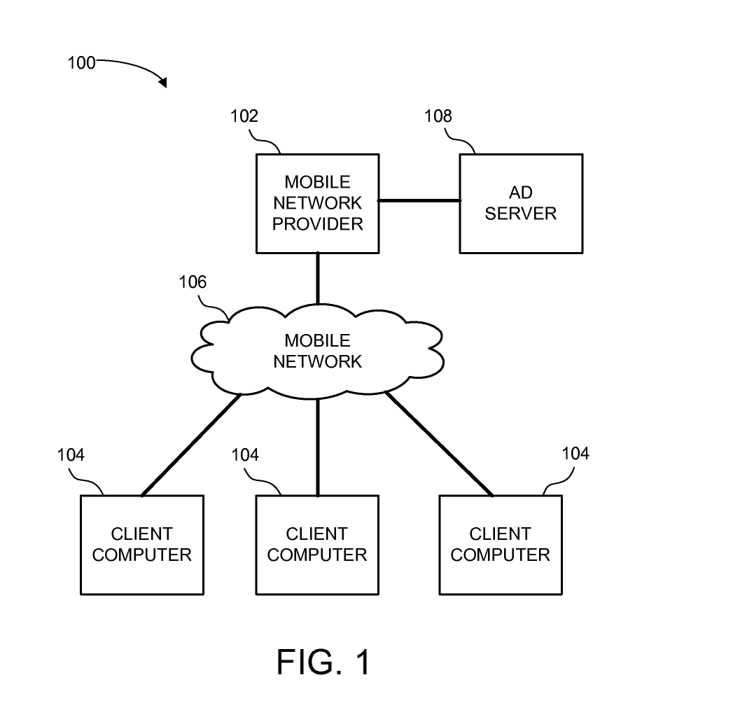

FIG. 1 depicts a schematic diagram of one embodiment of a mobile network system 100. The illustrated mobile network system 100 includes a mobile network provider 102, a client computer 104, a mobile network 106, and an ad server 108. The mobile network system 100 may provide an interface between a system user (not shown) and a mobile network provider 102 according to the interface operations of the client computer 104. Although the depicted mobile network system 100 is shown and described herein with certain components and functionality, other embodiments of the mobile network system 100 may be implemented with fewer or more components or with less or more functionality.

Additionally, some embodiments of the mobile network system 100 include similar components arranged in another manner to provide similar functionality, in one or more aspects. In one embodiment, the mobile network provider 102 operates over a plurality of mobile networks 106. For example, the mobile network provider 102 may provide services for a variety of mobile networks 106 according to geographic location.

The illustrated mobile network provider 102 hosts a mobile network 106 to provide mobile communication services to at least one client computer 104. In one embodiment, the mobile network provider 102 represents hardware owned and/or operated by a telephone company that provides mobile communication services to one or more mobile phone subscribers over a radio spectrum license. The mobile network provider 102 routes voice calls and data communications such as the internet, electronic mail, and SMS text messages. The mobile network provider 102 also provides other services such as mobile television services, Global Positioning System (GPS) services, conference calls such as video conference calls, and other circuit switched data. In some embodiments, the mobile network provider 102 may be configured to provide mobile communication services to several geographic locations. A predefined geographic area is hosted by a single server instance in one embodiment. Alternatively, a predefined geographic area is hosted by an array of mobile communication servers.

In one embodiment, the mobile network provider 102 includes a dedicated server. Alternatively, the mobile network provider 102 is configured as an array of servers. Some embodiments of the mobile network provider 102 include at least one ad server 108 dedicated to mobile advertising. The mobile network provider 102 may also include one or more storage servers, apart from the one or more ad servers 108, dedicated to storing data related to an advertisement and the calculation of a purchase probability.

The illustrated client computer 104 manages the interface between a system user such as a subscriber to the mobile network 106 and the mobile network provider 102. In one embodiment, the client computer 104 is a mobile computing device that allows a user to connect to the mobile network provider 102. The connection of the client computer 104 to the mobile network provider 102 allows the client computer 104 to access a service of the mobile network provider 102. Additionally, the connection of the client computer 104 to the mobile network provider 102 allows the mobile network provider 102 to interact with the client computer 104 to send a mobile advertisement to the client computer 104. In other embodiments, the client computer 104 is a desktop computer or a laptop computer. In some embodiments, the client computer 104 is a laptop computer that is equipped with a network interface that allows the laptop computer to gain access to the mobile network 106. In some embodiments, the client computer 104 is a video game console. For example, the client computer 104 may be a portable video game console with a network interface that allows the portable video game console to gain access to the mobile network 106. The client computer 104 is connected to the mobile network provider 102 via a wireless network or some other type of mobile network 106.

The illustrated mobile network 106 may communicate traditional block I/O. Alternatively, the mobile network 106 may communicate file I/O. In other embodiments, the mobile network 106 may communicate a combination of block I/O and file I/O. In some embodiments, the mobile network system 100 includes two or more mobile networks 106, in which each mobile network may serve a separate geographic area. Alternatively, each mobile network 106 may serve some combination of geographic areas. In one embodiment, the mobile network 106 includes a cellular network or some combination of wireless and wired networks based on one or more communication standards and protocols.

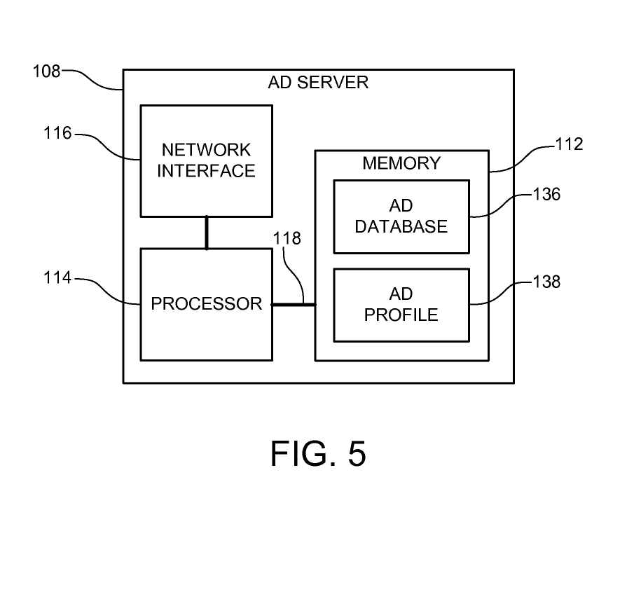

The illustrated ad server 108 serves, or communicates, a mobile advertisement to the client computer 104 of a subscriber to the mobile network 106. In one embodiment, the ad server 108 stores the mobile advertisement in a storage device (see FIG. 5) in the ad server 108. Alternatively, the storage device may be located apart from the ad server 108. Hence, the ad server 108 may send a command to an off-site storage device to send a mobile advertisement stored on the storage device to the client computer 104. In some embodiments, the ad server 108 is an integrated component of the mobile network provider 102. Alternatively, the ad server 108 is a server that runs independent from the mobile network provider 102. In one embodiment, the ad server 108 is an integrated component of the client computer 104. Alternatively, the ad server 108 includes multiple hardware and software components that are dispersed among the mobile network provider 102 and one or more client computer 104 or among several client computers 104 such as in a cloud-computing format. In some embodiments, the ad server 108 includes one or more hardware or software components dispersed among in some combination over at least one of the mobile network provider 102, client computer 104, and the mobile network 106.

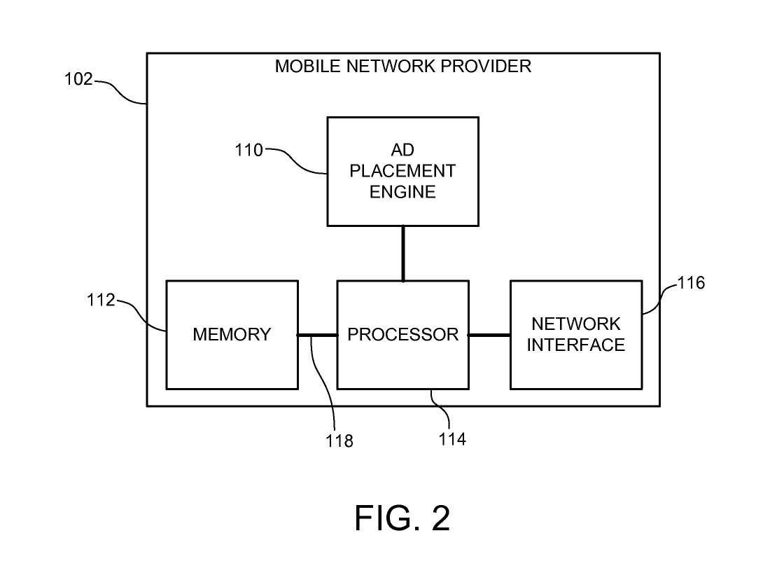

FIG. 2 depicts a schematic diagram of one embodiment of a mobile network provider 102 of the mobile network system 100 of FIG. 1. The illustrated mobile network provider 102 includes an ad placement engine 110, a memory device 112, a processor 114, a network interface 116, and a bus interface 118. Although the depicted mobile network provider 102 is shown and described herein with certain components and functionality, other embodiments of the mobile network provider 102 may be implemented with fewer or more components or with less or more functionality.

The illustrated ad placement engine 110 calculates a purchase probability to determine a probabilistic measure of a consumer's purchase behavior. In some embodiments, the ad placement engine 110 operates according to the LPP in order to calculate the purchase probability. In one embodiment, the ad place engine 110 implements an algorithm to calculate the purchase probability based on information unique to the consumer. Embodiments of the process of calculating a purchase probability are described in further detail below in relation to FIG. 4.

The illustrated memory device 112 stores a parameter related to the LPP. In some embodiments, the parameter is used in conjunction with the processes to calculate a purchase probability. In one embodiment, the memory device 112 is a random access memory (RAM) or another type of dynamic storage device. In some embodiments, the illustrated memory device 112 is representative of both RAM and static storage memory within a single mobile network system 100. In one embodiment, the memory device 112 is an electronically programmable read-only memory (EPROM) or another type of storage device. Additionally, some embodiments of the memory device 112 store instructions related to the operational functionality of the mobile network provider 102. These instructions may include some combination of software and firmware such as embedded foundation code, basic input/output system (BIOS) code, or other similar code.

In one embodiment, the processor 114 is a central processing unit (CPU) with one or more processing cores. Alternatively, the processor 114 is a graphical processing unit (GPU) or another type of processing device such as a general-purpose processor. Some embodiments of the processor 114 include an application specific processor, a multi-core processor, and a microprocessor. In general, the processor 114 executes one or more instructions to provide operational functionality to the mobile network provider 102. The instructions may be stored locally in the processor 114 or in the memory device 112. Alternatively, the instructions may be distributed across one or more devices such as the processor 114, the memory device 112, another data storage device on the mobile network provider 102, or some other device in the mobile network system 100 within or separate from the mobile network provider 102. The illustrated processor 114 processes a parameter according to the LPP. In some embodiments, the parameter is processed in conjunction with the processes to calculate a purchase probability.

The network interface 116, in one embodiment, implements functionality by which the ad placement engine 110 sends a calculated probability parameter to the ad server 108. In some embodiments, the network interface 116 facilitates initial connections between the client computer 104 and the mobile network provider 102 in response to a subscriber on the client computer 104 requesting to log into or otherwise access the mobile network 106. The network interface 116 allows the client computer 104 to maintain a connection to the mobile network provider 102 through the mobile network 106. In some embodiments, the network interface 116 handles communications and commands between the client computer 104 and the mobile network provider 102. The communications and commands are exchanged over the mobile network 106.

In one embodiment, the memory device 112, the processor 114, the network interface 116, and other components within the mobile network system 100 are coupled to a bus interface 118. The bus interface 118 may provide simplex or duplex communications of data, address, and/or control information. In one embodiment, the bus interface 118 facilitates communications related to processes associated with the ad placement engine 110 executing a function on the mobile network provider 102. These processes include processing mobile network commands, as well as storing, sending, and receiving data packets associated with the mobile network 106.

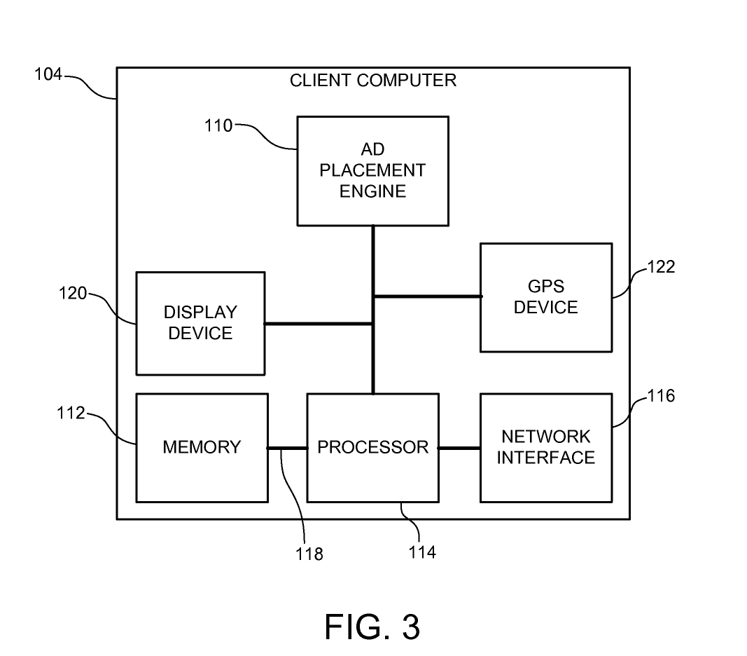

FIG. 3 depicts a schematic diagram of one embodiment of a client computer 104 of the mobile network system 100 of FIG. 1. The illustrated client computer 104 includes an ad placement engine 110, memory device 112, a processor 114, a network interface 116, a bus interface 118, a display device 120, and a GPS device 122. The illustrated client computer 104 of FIG. 3 includes many of the same or similar components (with the same or similar number designations) as the mobile network provider 102 of FIG. 2. These components are configured to operate in substantially the same manner described above, except that the functionality is implemented on the client device 104, rather than the mobile network provider 102. Other differences are noted below. Although the depicted client computer 104 is shown and described herein with certain components and functionality, other embodiments of the client computer 104 may be implemented with fewer or more components or with less or more functionality.

The illustrated display device 120 displays a mobile advertisement. In one embodiment, the display device 120 is a graphical display such as a cathode ray tube (CRT) display, a liquid crystal display (LCD) display, a light emitting diode (LED) display, or another type of display device. In one embodiment, the display device 120 displays a mobile advertisement according to the LPP. The display device 120 displays the mobile advertisement in response to the calculation of a purchase probability.

The illustrated GPS device 122 detects navigation information that includes a current location of a client computer 104. Additionally, in some embodiments, when the client computer 104 is moving, the GPS device 122 detects the direction in which the client computer 104 is heading as well as the speed at which the client computer 104 is moving.

In one embodiment, the illustrated GPS device 122 sends the detected navigation information to the mobile network provider 102. The mobile network provider 102 assumes that the owner of the client computer 104, a subscriber to the mobile network 106, is at the location where the GPS device 122 reports the client computer 104 to be. The mobile network provider 102 may deduce the location to which the subscriber is going based on at least the detected direction in which the client computer 104 is moving. Additionally, the mobile network provider 102 may use historical data of past locations. Additionally, the mobile network provider 102 may deduce the mode of travel in which the subscriber is traveling based on at least the detected speed at which the client computer 104 is moving. For example, if the GPS device 122 detects that the client computer 104 is moving at a speed of 50 miles per hour (MPH), then the mobile network provider 102 may assume that the client computer 104 is moving by some form of mechanical transportation such as automobile or train. On the other hand, if the GPS device 122 detects that the client computer 104 is moving at a speed of 4 MPH, then the mobile network provider 102 may assume that the client computer 104 is walking or jogging. In one embodiment, at least one element of the navigation information that the GPS device 122 sends to the mobile network provider 102 is used within the LPP to calculate a purchase probability.

FIG. 4 depicts a schematic diagram of one embodiment of an ad placement engine 110 for use with the mobile network provider 102 of FIG. 2 and/or the client computer 104 of FIG. 3. Although the ad placement engine 110 is described below for use with the mobile network provider 102, other embodiments of the ad placement engine 110 may be implemented in conjunction with the client computer 104, or some combination of the mobile network provider 102 and the client computer 104.

The ad placement engine 110 determines a purchase probability. In other words, the ad placement engine 110 determines the likelihood that a subscriber to the mobile network 106 will purchase an item at a predefined point of sale, or purchase point, of a certain vendor. In one embodiment, the ad placement engine 110 operates according to a LPP. The ad placement engine 110 determines which ads to place on the client computer 104. For example, in response to the determination that the user is currently using a text-messaging application, the ad placement engine 110 sends the ad to the user by way of an SMS text message.

The illustrated ad placement engine 110 includes a memory device 112, a processor 114, a bus interface 118, and an ad selector 124. The illustrated ad selector 124 includes an ad monitor 126, and a profile generator 128. The memory device 112 illustrated in FIG. 4 stores a user profile 130, a location probability database 132, and an ad placement algorithm 134. The illustrated ad placement engine 110 of FIG. 4 includes many of the same or similar components as the mobile network provider 102 of FIG. 2. These components are configured to operate in substantially the same manner described above, except as noted below. Although the depicted ad placement engine 110 is shown and described herein with certain components and functionality, other embodiments of the ad placement engine 110 may be implemented with fewer or more components or with less or more functionality.

The illustrated ad selector 124 compares an element of the user profile 130 with a parameter from the ad server 108. Additionally, the ad selector 124 selects an ad based on a probability parameter such as the purchase probability and the comparison of the elements from the user profile 130 and the ad server 108. In one embodiment, the ad selector 124 facilitates the placement of the selected ad on the client computer 104.

The illustrated ad monitor 126 monitors the placement of the selected ad on the client computer 104. In one embodiment, the ad monitor 126 determines a subscriber response to the placement of the selected ad on the subscriber's client computer 104. The effectiveness of a mobile ad campaign may be measured by impressions, or views, and click-through rates. Additional measurements include conversion rates, such as click-to-call rates and other degrees of interactive measurement.

The illustrated profile generator 128 generates the user profile 130 based on information related to the subscriber such as the subscriber's name, home address, phone number, and other similar data. Generation of the user profile 130 may include a user registration. The user registration may include a process to build the user profile based on user settings at the time of registration, which may include input generated by the subscriber. Generation of the user profile 130 may also include a process to store previous purchases in relation to location and mobile analytics such as previous queries, appointments, routes typically used by subscriber, etc. Additionally, the profile generator 128 updates the user profile 130 based on the response to the placement of the selected ad on the subscriber's client computer 104.

The illustrated user profile 130 includes at least one of the elements of personal data described above. Additionally, the user profile 130 may include at least one of the following elements: the current time of day, a home location, a current distance to the home location, a current distance to a purchase point, a previous location, and a timestamp associated with the previous location. The user profile 130 may also include a typical route pattern, a purchase history, a query history, a calendar appointment, an application preference, and/or navigation information that includes a current location, direction, and/or speed. In one embodiment, the location probability database 132 stores at least one of the elements included in the user profile 130.

In one embodiment, at least one of the elements in the user profile 130 or the location probability database 132 is included in the ad placement algorithm 134. For example, the current location of the client computer 104 may be configured as an independent variable in the ad placement algorithm 134. The processor 114 determines a purchase probability by computing the ad placement algorithm 134 with at least one of the elements of the user profile 130 or the location probability database 132 included in the ad placement algorithm 134. In some embodiments, the location probability database 132 stores the result of the computation of the ad placement algorithm 134, which includes the purchase probability.

The illustrated location probability database 132 stores at least one of the following elements: an element of the navigation information, an element of the user profile, or the purchase probability parameter. In one embodiment, the location probability database 132 sends the calculated purchase probability to the ad server 108 through the network interface 116 of the mobile network provider 102. Alternatively, the location probability database 132 sends the calculated purchase probability to the ad server 108 through the network interface 116 of the client computer 104.

In one example, a drug store, which operates several drug stores in different geographic areas, runs a mobile advertisement campaign to promote air-fresheners. The drug store's target consumer is currently in Redwood City, Calif. The drug store could place a mobile ad for air-fresheners on the consumer's mobile phone based on the subscriber's current location of Redwood City. However, the subscriber is in Redwood City only for a short business meeting. Hence, the probability of converting this mobile ad into a purchase for this subscriber is very low. The LPP determines this information beforehand and allows the advertiser to decide whether to place an ad on the subscriber's phone based on additional information generated by the LPP process.

In one embodiment, at least one element from the user profile 130 populates a location probability table (not shown) that is stored in the location probability database 132. Based on the drug store example, the location probability database 132 may include the following Location Probability Table:

Location Probability Table

| | | Distance | | | Frequency of | Price | |
|---|---|---|---|---|---|---|---|
| | Current | to Home | | Distance | Purchases | Promotion | Web Trend |
| Purchase | Location | Location | | to PP | at PP | (Yes/No) | (High, Low) |
| (Yes, No) | (A) | (B) | | (C) | (D) | (E) | (F) |
| 1 | Sunnyvale | 5 | miles | 4 | 4 | 0 | 1 |
| 1 | Redwood City | 4 | Miles | 3 | 2 | 0 | 1 |
| 1 | Santa Clara | 3 | Miles | 5 | 2 | 0 | 1 |
| 0 | Las Vegas | 550 | Miles | 500 | 0 | 0 | 1 |
| 1 | Milipitas | 1 | Mile | 0 | 10 | 1 | 1 |
| 1 | Mountain View | 5 | Miles | 3 | 3 | 0 | 1 |

(1 = Yes, 0 = No; PP = Purchase Point)

The Location Probability Table illustrated above includes columns for Purchase, Current Location (A), Distance to Home Location (B), Distance to PP (C), Frequency of Purchases at PP (D), Price Promotion (Yes/No) (E), and Web Trend (High, Low) (F). In general, the Location Probability Table describes (past) purchase behavior of a sample set of subscribers. This table provides an understanding of one embodiment of the relationship between the independent variables (distance to home, location, distance to PP, frequency of purchase at PP, effect of price promotion on purchase, etc.) to the dependent variable (purchase). For example, an advertising company or another user can gather the purchase behavior of a random sample of subscribers and populate this table. The variables used within the table are:
Purchase—This variable indicates a subscriber's decision of purchase of the given item (air fresher, toothpaste, milk etc.) In one embodiment, this variable is either 1 or 0, to indicate that the subscriber did or did not purchase.
Current Location—this variable indicates the current location of the subscriber. This variable can be further encoded to fit the Probit equation (in terms of miles). This can also be an optional variable in the Probit equation.
Distance to Home Location—Home location is the permanent location of the subscriber. For example, if the subscriber is a resident of San Jose, but travels to Redwood City daily for work, then the subscriber's home location is San Jose. An ad vendor can decide to specify which location is the “real home location” for a subscriber. If the subscriber spends more time outside his or her actual home location, then the ad vendor might define the subscriber's home location as the place where the subscriber spends a significant amount of time. In the previous example, if the subscriber spends a significant amount of time at work in Redwood City, then an ad vendor might decide to make Redwood City the home location for that subscriber. In any case, distance to home location is the distance between the current location and subscriber's assigned home location.
Distance to PP—This variable measures the distance between the current location and the purchase point (e.g., distance to the nearest store).
Frequency of Purchases at PP—This variable measures the number of times a subscriber has shopped at a given purchase point.
Price Promotion (Yes/No)—This variable indicates whether there was price promotion (TPR—temporary price reduction, display ads, etc.) or any other type of marketing promotion running at a given purchase point. This variable can indicate or be used to determine if a promotion was successful in enticing a customer to a store.
Web Trend (High, Low)—This variable indicates the level of internet activity of the subscriber. The internet activity could be directly related to the product for which an ad vendor considers placing an ad. For example, if the subscriber is shopping around for price for a particular LCD TV, then the knowledge of this searching activity could help an ad vendor to place an appropriate ad on the phone. This variable need not be related to a particular product or ad vendor relative to the searching activity. If a subscriber is web-savvy on his/her phone, then this variable can indicate some level of web usage. In turn, this indication may be meaningful to some ad vendors to indicate a higher probability of a web-savvy user who might click on an ad placed on his/her phone, compared with a less web-savvy user who might be less likely to use mobile ads.

According to the Location Probability Table described above, the advertiser might conclude that it does not make sense to place an ad with the consumer for the air freshener in the Redwood City drug store. Based on the correlation between the distance to purchase point and the past purchase behavior, the drug store may determine that it makes sense to place an ad for the Milipitas drug store.

In one embodiment, the ad placement algorithm 134 is based on a correlation function extrapolated based on independent variables such as the variables A-F in the table above. Such a model can be adapted in real-time. One example of the ad placement algorithm 134 is a Probit function with a result between 0 and 1. In one embodiment, the ad placement algorithm 134 is implemented by the following equation:

$$Probability of Purchase = \frac{1}{1 + {e}^{- x}} , where$$

$$x = ( α + {β}_{1} {x}_{1} + {β}_{2} {x}_{2} + {β}_{3} {x}_{3} … ) + Δ .$$

As used in the ad placement algorithm 134 presented above, the variables are defined as follows:
α is the intercept value of the equation. When the effect of all other dependent variables on the purchase is zero, then the purchase decision is a direct function of the value of the intercept. This intercept value is a constant.
βᵢ are the regression co-efficients of parameters (in the Location Probability Table above): A—Current Location, B—Distance to Home Location, etc. Each of the regression coefficients describes the size of the contribution of that risk factor. A positive regression coefficient means that the explanatory variable (A, B, C, etc. per the table) increases the probability of the outcome, while a negative regression coefficient means that the variable decreases the probability of that outcome. Also, a large regression coefficient means that the risk factor (A, B, C, etc. per the table) strongly influences the probability of purchase, while a near-zero regression coefficient means that that risk factor (A, B, C, etc. per the table) has little influence on the probability of that purchase.
χ represents dependent variables in the equation—A, B, C, D . . . etc. per the table. In this example, there are 6 dependent variables (A to F). Other embodiments may have fewer or more variables.
Δ represents the error factor or the residual in the equation. The intent is to keep this factor minimum. This is a combination of one or more factors that do not really describe the purchase behavior of the subscriber. This can indicate an impulse purchase by subscribers even though it might not make sense logically to purchase something at the purchase location.

By running this multivariate regression on these variables (A, B, C, D, E, F etc. as shown in the table), a user can obtain the relationship between “purchase” and circumstantial factors like “current location, frequency of purchase, distance to home location, etc. The relationship is described in the above equation. By running this regression and building this relationship equation for a sample set of subscribers, the relationship can then be extrapolated to a large set of subscribers at any given time. In some embodiments, the correlation between the variables and purchase decision is the key factor in this algorithm. Of course, there may be an error margin (Δ), but in some embodiments that can decreased or minimized by having more accurate variables that describe the relationship between purchase decision and dependent variables.

Based on the drug store example above, the probability that the consumer from the example will make a purchase at any given store or purchase point may be calculated by the following example-specific equation:

$$Probability of Purchase = \frac{1}{1 + {e}^{( α + {β}_{1} ( A ) + {β}_{2} ( B ) + {β}_{3} ( C ) + {β}_{4} ( D ) + {β}_{5} ( E ) + {β}_{6} ( F ) + Δ )}} .$$

Using this real-time calculation may benefit a vendor running a mobile advertising campaign. Implementing a Probit function to determine a purchase probability allows a vendor to determine in real-time the probability that a targeted consumer will make a purchase at their purchase point. By enabling the vendor to make an informed ad-placement decision in a timely manner, the vendor may increase the probability that placing an ad will convert into a purchase.

Using this real-time calculation may also benefit the targeted consumer. By including one or more aspects of the consumer's past purchase behavior and the settings of the consumer's user profile 130 in the real-time calculation, the consumer receives an ad personalized to his or her own tastes and preferences.

In some embodiments, the ad placement engine 110 is implemented within the mobile network system 100 to provide certain advantages over conventional technologies. For example, some embodiments of the mobile network system 100 implement the ad placement engine 110 to increase the yield of mobile advertisement campaigns. Other embodiments of the mobile network system 110 may implement the ad placement engine 110 to achieve other advantages.

In addition to the advantages that may be achieved by implementation of the individual components of the mobile network system 100, some embodiments of the mobile network system 100 provide additional advantages over conventional technology. For example, some embodiments of the mobile network system 100 allow competitive bidding of advertisement spots between ad networks. Advertisers can save money by paying less for an ad sent to a subscriber with a lower probability. Additionally, mobile network providers 102 can charge advertisers more for an ad sent to a subscriber whose probability of purchase is higher, producing the results desired by vendors and a way for measuring those results. Additionally, some embodiments of the mobile network system 100 allow advertisers to place an ad with specific consumers who are currently located close to specific purchase points (e.g., while shopping in at a mall, grocery store, etc.). Consumers benefit from ads targeted to enhance their current shopping habits. Such targeted ads aim to inform the consumer by replacing meaningless spam with a personalized ad.

In some embodiments, the system described herein enhances the shopping experience for the subscriber, increases the yield of an ad to the ad vendor, and also facilitates a closed-loop marketing campaign with the ability to track the impact of a specific advertisement almost instantaneously. This is because the subscribers almost always carry their mobile phone (or other mobile communications device) to the point-of-purchase where the vendor can scan the coupon or the ad that was placed on the subscriber's device. This allows the ad vendor to immediately, or relatively quickly, acknowledge whether the ad that was placed on the subscriber's device yielded the desired purchase result. This and other types of insight into subscriber behavior can further help an ad vendor to refine their advertisement campaigns.

FIG. 5 depicts a schematic diagram of one embodiment of an ad server 108 of the mobile network system 100 of FIG. 1. The illustrated ad server 108 includes a memory device 112, a processor 114, a network interface 116, and a bus interface 118. The illustrated memory device 112 includes an ad database 136 and an ad profile 138. The illustrated ad server 108 of FIG. 5 includes many of the same or similar components as the mobile network provider 102 of FIG. 2. These components are configured to operate in substantially the same manner described above, except as noted below. Although the depicted ad server 108 is shown and described herein with certain components and functionality, other embodiments of the ad server 108 may be implemented with fewer or more components or with less or more functionality.

In one embodiment, the ad database 138 stores an ad. In some embodiments, the ad database 138 is stored independent from the mobile network provider 102, the client computer 104, and the mobile network 106. Alternatively, elements of the ad database 138 are distributed across one or more of the memory devices 112 of the mobile network provider 102, the client computer 104, and the ad server 108.

The illustrated ad profile 136 also stores data relative to a vendor's ad campaign such as a characteristic of a target consumer, a predefined period of time during which the ad may run, and an acceptable mode of placing the ad on the client computer 104. In one embodiment, the profile generator 126 allows an advertiser to generate the ad profile 136. In some embodiments, the ad profile 136 includes bid criteria for a vendor. In other words, the vendor may set one or more thresholds at which the vendor wants one of their ads to be placed on a subscriber's client computer 104 based on the calculated purchase probability for that subscriber. In some embodiments, the vendor sets predefined bid thresholds. The predefined bid threshold scheme allows a vendor to determine automatically whether the vendor will place an ad on the client computer 104 of the potential customer. For example, the vendor may set the threshold to be triggered when the calculated purchase probability for the subscriber is at or above 75% probability. Hence, whenever the probability that the subscriber would purchase an item from that vendor was 75% or higher, then an ad for the vendor would be sent to the subscriber's client computer 104.

In other embodiments, the vendor is notified in advance of the likelihood of the subscriber's purchase probability for an item from the vendor. The notification scheme allows the vendor to decide in real-time whether to place the ad on the client computer 104.

In one embodiment, the vendor sets multiple bids for ad space on a subscriber's client computer 104 based on multiple thresholds. For example, the vendor may set a first bid of $2 for a purchase probability of 90% or higher. The vendor may set a second bid of $1.50 to be triggered when the calculated purchase probability for the subscriber is at or above 80% probability. The vendor may set a third bid of $1 for a purchase probability of 70% or higher, and so forth. Hence, a single vendor may automatically determine whether to send a potential customer an ad based on the probability of that customer purchasing an item from that vendor's location.

In one embodiment, two or more vendors compete for a single available ad space. Alternatively, multiple vendors compete for two or more available ad spaces on the client computer 104. For example, a web site displayed on the display device 120 of the client computer 104 may have space for only three advertisements. Each vendor may set predefined bid thresholds that automatically determine whether the vendor will attempt to place an ad on the client computer 104 of the potential customer. The mobile network provider 102 selects the one or more vendors with the winning bids.

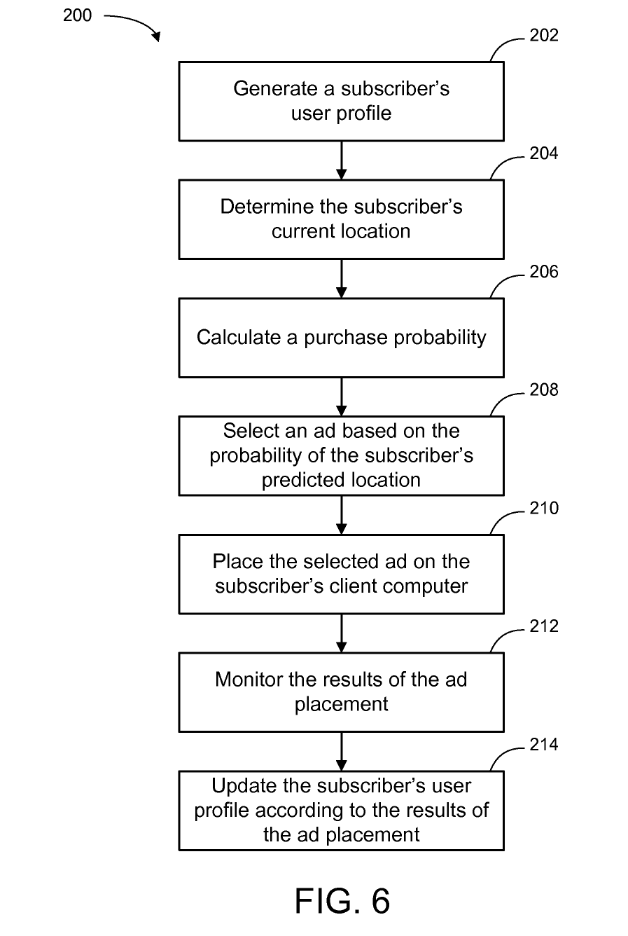

FIG. 6 depicts a flow chart diagram of one embodiment of a location prediction method 200 for use with the ad placement engine 110 of FIG. 4. Although the method 200 is described in conjunction with the ad placement engine 110 of FIG. 1, embodiments of the method 200 may be implemented with other types of ad placement engines.

At block 202, the profile generator 126 generates a user profile 130 of a subscriber to the mobile network 106. At block 204, the GPS device 122 determines the current location of the subscriber. The client computer 104 sends the navigation information from the GPS device 122 to the mobile network provider 102. In other embodiments, the mobile network provider 102 determines the current location of the subscriber by a process of triangulation.

At block 206, the processor 114 calculates a purchase probability. In one embodiment, the calculation of the purchase probability occurs on the mobile network provider 102. Alternatively, the calculation of the purchase probability may occur on the client computer 104. In some embodiments, the calculation of the purchase probability occurs on the ad server 108. Alternatively, the calculation of the purchase probability takes place in an operation that is performed by some combination of the mobile network provider 102, the client computer 104, and/or the ad server 108.

At block 208, the ad selector 124 selects an ad based on the probability of the subscriber's probability of purchase. In one embodiment, the ad selector 124 compares the user profile 130 with an ad profile 136. In some embodiments, the ad selector 124 selects an ad based on the probability parameter and the comparison of the user profile 130 and the ad profile 136. At block 210, the ad selector 124 places, or facilitates the placement of, the selected ad on the subscriber's client computer 104.

At block 212, the ad monitor 128 monitors the results of the ad placement. For example, the ad monitor 128 monitors whether a subscriber clicks on an ad placed on the subscriber's client computer 104. Also, the ad monitor 128 monitors whether the subscriber purchases the item in the ad. At block 214, the profile generator updates the subscriber's user profile 130 according to the results of the ad placement. In other words, if the subscriber purchases the item in the ad, then the user profile 130 of the subscriber is updated with a parameter indicating that the ad placement was a success. Other pertinent information surrounding the circumstances of the purchase such as the time of day and whether the vendor was located on the subscriber's typical route may also be included in the update of the user profile 130. The depicted method 200 then ends.

Some embodiments of the mobile network system 100 implement the ad placement engine 110 to increase the mobile advertisement yield. Embodiments of the mobile network system 100 increase the yield of mobile advertisements by providing an accurate targeting measure and improved tracking of purchase conversion rates than what is presently possible. Embodiments of the mobile network system 100 provide a probabilistic measure of consumer's purchase behavior by utilizing current location, navigation information, past purchase behavior, and/or mobile analytics. The mobile network system 100 also improves the mobile advertisement campaigns by providing customers with ads personalized to their own liking and/or historical habits, thus reducing or minimizing the impersonal, indiscriminate advertising known as spam.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

An embodiment of a mobile network system 100 includes at least one ad placement engine 110 coupled directly or indirectly to memory elements through a system bus such as a data, address, and/or control bus. The memory elements can include local memory employed during actual execution of the program code, bulk storage, and cache memories that provide temporary storage of at least some program code in order to reduce the number of times code must be retrieved from bulk storage during execution.

It should also be noted that at least some of the operations for the methods might be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. An apparatus comprising:
an ad placement engine to calculate a probability parameter, the ad placement engine comprising:
a processor to implement an ad placement algorithm dependent on navigation information and at least one parameter from a user profile in order to determine the probability parameter, wherein the probability parameter comprises a probability of a purchase in response to an ad placement;
a memory to store a location probability database, the location probability database comprising the probability parameter; and
a network interface to allow the ad placement engine to send to an ad server the calculated probability parameter.

2. The apparatus of claim 1, the ad placement engine further comprising an ad selector, the ad selector to compare the user profile with an ad profile, to select an ad based on the probability parameter and the comparison of the user and ad profiles, and to place the selected ad.

3. The apparatus of claim 2, wherein the ad selector comprises an ad monitor, the ad monitor to monitor the placement of the selected ad and to monitor a subscriber response to the ad placement.

4. The apparatus of claim 3, wherein the ad selector further comprises a profile generator coupled to the ad selector, the profile generator to generate the user profile and to update the user profile based on the response to the ad placement.

5. The apparatus of claim 1, wherein the ad placement algorithm comprises a Probit function for multivariate regression according to the following equation:
$$Probability = \frac{1}{1 + {e}^{- x}} , where$$
$$x = ( α + {β}_{1} {x}_{1} + {β}_{2} {x}_{2} + {β}_{3} {x}_{3} … ) + Δ .$$

6. The apparatus of claim 1, wherein the memory is further configured to store the ad placement algorithm.

7. The apparatus of claim 1, wherein the memory is further configured to store at least one element of the user profile.

8. The apparatus of claim 7, wherein the at least one element of the user profile comprises a current time of day, a home location, a current distance to the home location, a current distance to a purchase point, a previous location, a timestamp associated with the previous location, a typical traffic pattern, a purchase history, a query history, a calendar appointment, an application preference, or navigation information that includes a current location, direction, and speed.

9. A computer program product comprising a computer useable storage medium to store a computer readable program for calculation of a probability parameter, wherein the computer readable program, when executed on a computer, causes the computer to perform operations comprising:
receiving navigation information from a client computer;
implementing an ad placement algorithm dependent on navigation information and at least one parameter from a user profile in order to determine the probability parameter, wherein the probability parameter comprises a probability of a purchase in response to an ad placement;
storing a location probability database, the location probability database comprising of at least one element from the following: the navigation information, an element of the user profile, and the probability parameter; and
sending to an ad server the calculated probability parameter.

10. The computer program product of claim 9, further comprising:
comparing the user profile with an ad profile;
selecting an ad based on the probability parameter and the comparison of the user and ad profiles; and
placing the selected ad.

11. The computer program product of claim 10, further comprising:
monitoring the placement of the selected ad; and
determining a subscriber response to the ad placement.

12. The computer program product of claim 11, further comprising:
generating the user profile; and
updating the user profile based on the response to the ad placement.

13. The computer program product of claim 9, further comprising calculating the probability parameter based on a Probit function for multivariate regression according to the following equation:
$$Probability = \frac{1}{1 + {e}^{- x}} , where$$
$$x = ( α + {β}_{1} {x}_{1} + {β}_{2} {x}_{2} + {β}_{3} {x}_{3} … ) + Δ .$$

14. The computer program product of claim 9, further comprising storing the ad placement algorithm and the user profile, wherein the user profile comprises at least one element of a plurality of elements, wherein the plurality of elements comprises: current time of day, a home location, a current distance to the home location, a current distance to a purchase point, a previous location, a timestamp associated with the previous location, a typical traffic pattern, a purchase history, a query history, a calendar appointment, an application preference, and navigation information that includes a current location, direction, and speed.

15. The computer program product of claim 9, further comprising sending an ad to the client computer for display on a display device.

16. A method comprising:
sending navigation information to a mobile network provider;
implementing an ad placement algorithm to process the navigation information in conjunction with a user profile in order to determine a probability parameter, wherein the probability parameter comprises a probability of a purchase in response to an ad placement;
storing a location probability database, the location probability database comprising at least one element from the following: the navigation information, the user profile, and the probability parameter; and
providing an ad server the calculated probability parameter.

17. The method of claim 16, further comprising:
comparing the user profile with an ad profile;
selecting an ad based on the probability parameter and the comparison of the user and ad profiles;
placing the selected ad;
displaying the selected ad on a display device;
monitoring the placement of the selected ad; and
determining a subscriber response to the ad placement.

18. The method of claim 17, further comprising:
generating the user profile; and
updating the user profile based on the response to the ad placement.

19. The method of claim 16, further comprising calculating the probability parameter based on a Probit function for multivariate regression according to the following equation:
$$Probability = \frac{1}{1 + {e}^{- x}} , where$$
$$x = ( α + {β}_{1} {x}_{1} + {β}_{2} {x}_{2} + {β}_{3} {x}_{3} … ) + Δ .$$

20. The method of claim 16, further comprising storing the user profile, wherein the user profile comprises at least one of the following elements: current time of day, a home location, a current distance to the home location, a current distance to a purchase point, a previous location, a timestamp associated with the previous location, a typical traffic pattern, a purchase history, a query history, a calendar appointment, an application preference, and the navigation information that includes a current location, direction, and speed.
